(19) United States
(12) Patent Application Publication
(10) Pub. No.: US 2025/0033231 A1
(43) Pub. Date: Jan. 30, 2025

(54) A HAIR TRIMMING SYSTEM

(71) Applicant: KONINKLIJKE PHILIPS N.V., EINDHOVEN (NL)

(72) Inventors: GEERT-JAN DARWINKEL, WINSUM (NL); MERLIJN SHIVAN WIEBE HULZENGA, EINDHOVEN (NL); WOUTER VAN KEMPEN, SAPPEMEER (NL)

(21) Appl. No.: 18/716,300

(22) PCT Filed: Nov. 17, 2022
(86) PCT No.: PCT/EP2022/082282

§ 371 Date: Jun. 4, 2024

(30) Foreign Application Priority Data
Dec. 8, 2021 (EP) 21213171.8

(51) Int. Cl. B26B 19/38; B26B 19/04

(52) U.S. Cl. CPC B26B 19/386; B26B 19/048

(57) ABSTRACT

According to an aspect, there is provided a hair trimming system comprising a handle and a head, the head comprising a cutting unit for cutting hairs, and the head being moveable relative to the handle, wherein: the head comprises a base configured to be received in the handle, wherein the base comprises a connecting portion configured to cooperate with the handle to connect the handle and the head, and to permit pivoting movement of the head with respect to the handle about the connecting portion, and the base comprises a main indentation and an intermediate indentation; the handle comprises a holding mechanism comprising a moveable stop configured to be received separately in each of the main indentation and in the intermediate indentation, to restrict pivoting movement of the head relative to the handle about the connecting portion so as to secure the head to the handle, wherein the stop is biased to a locked position relative to the handle, wherein in the locked position, the stop is received in one of the main indentation and the intermediate indentation, to secure the head to the handle, wherein when the stop is received in the main indentation, the base of the head is received within the handle in an operational configuration, and when the stop is received in the intermediate indentation, the head is pivoted away from the handle relative to the operational configuration, in an open configuration.

### FIELD OF THE INVENTION

The invention relates to a hair trimming system for cutting hairs.

### BACKGROUND OF THE INVENTION

Hair trimming systems typically comprise a handle and a head, the head comprising a cutting unit to cut hairs. In some hair trimming systems, the cutting unit can become clogged with hairs which are difficult to clean from the cutting unit. In some previously considered hair trimming systems, the head is detachable from the handle, but detachment can be uncontrolled or difficult to achieve.

### SUMMARY OF THE INVENTION

According to a first specific aspect, there is provided a hair trimming system comprising a handle and a head, the head comprising a cutting unit for cutting hairs, and the head being moveable relative to the handle, wherein: the head comprises a base configured to be received in the handle, wherein the base comprises a connecting portion configured to cooperate with the handle to connect the handle and the head, and to permit pivoting movement of the head with respect to the handle about the connecting portion, and the base comprises a main indentation and an intermediate indentation; the handle comprises a holding mechanism comprising a moveable stop configured to be received separately in each of the main indentation and in the intermediate indentation, to restrict pivoting movement of the head relative to the handle about the connecting portion so as to secure the head to the handle, wherein the stop is biased to a locked position relative to the handle, wherein in the locked position, the stop is received in one of the main indentation and the intermediate indentation, to secure the head to the handle, wherein when the stop is received in the main indentation, the base of the head is received within the handle in an operational configuration, and when the stop is received in the intermediate indentation, the head is pivoted away from the handle relative to the operational configuration, in an open configuration.

The connecting portion may be disposed on an opposing side of the base to the main indentation and to the intermediate indentation.

The stop may be mounted on the end of a leaf spring.

The head may be detachable from the handle. The connecting portion of the head may comprise a locking hook and the handle may comprise a corresponding locking overhang to detachably retain the locking hook within the handle.

The hair trimming system may further comprise a release button disposed on the handle, and moveable with respect to the handle from a neutral position to a release position. The release button may be configured to abut the head when moved towards the release position, to push the head away from the handle, to pivot the head about the connecting portion relative to the handle.

The release button may be disposed on a guide rail describing an arcuate path, such that the release button is configured to move between the neutral position and the release position along the arcuate path.

The handle may comprise a release block configured to block movement of the release button beyond the release position, wherein when the release button abuts the head at the release position, the stop is received in the intermediate indentation.

The main indentation and the intermediate indentation may define a peak therebetween. The intermediate indentation may comprise a continuous surface from the peak to a trough of the intermediate indentation.

When the release button abuts the head at the release position, the stop may be received on the continuous surface between the peak and the trough of the intermediate indentation, such that a biasing force on the stop to the locked position causes the stop to propel the head away from the handle until the stop is received in the trough of the intermediate indentation.

The release button may comprise a protrusion configured to interact with the stop, to push or pull the stop away from the locked position when the release button is moved towards the release position.

The head may comprises two adjacent main indentations and two adjacent intermediate indentations, and the handle may comprise two corresponding stops, each stop configured to be received in one of the main indentations and one of the intermediate indentations.

The hair trimming system may comprising multiple interchangeable heads.

These and other aspects will be apparent from and elucidated with reference to the embodiments described hereinafter.

### BRIEF DESCRIPTION OF THE DRAWINGS

Exemplary embodiments will now be described, by way of example only, with reference to the following drawings, in which:

FIG. 1 schematically shows an oblique view of a first example hair trimming system;

FIGS. 2A and 2B schematically show an oblique view and a side view respectively of a head of the hair trimming system of FIG. 1;

FIGS. 3A to 3C schematically show cross-sectional views of the hair trimming system of FIG. 1 in an operational configuration, an intermediate configuration, and an open configuration respectively;

FIGS. 4A and 4B schematically show a different cross-sectional view of the first example hair trimming system in an operational configuration and an open configuration respectively;

FIG. 5A schematically shows a part of a second example hair trimming system; and

FIGS. 5B and 5C schematically show a cross-sectional view of the second example hair trimming system in an operational configuration and an open configuration respectively.

### DETAILED DESCRIPTION OF THE EMBODIMENTS

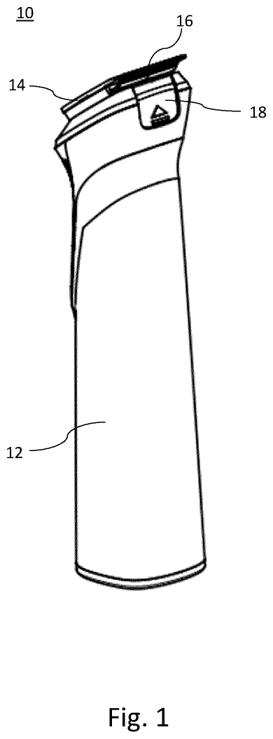

FIG. 1 shows a first example hair trimming system 10 comprising a handle 12 and a head 14. The handle 12 is configured to be held by a user, and the head 14 comprises a cutting unit 16 for cutting hairs, such as a blade. The handle 12 may comprise electronics and a moving mechanism to induce movement in the cutting unit 16, to cut hairs.

In this example, the head 14 is detachable from the handle 12 such that the head 14 is moveable relative to the handle 12, and when detached, it can be replaced with a different head. The hair trimming system 10 may therefore comprise multiple heads 14 which can each be detachably connected to the handle 12. In other examples, the head may simply be moveable relative to the handle, without being detachable. For example, the head may be connected by means of a pin to the handle such that it is pivotable relative to the handle about the pin, without allowing the head to detach from the handle.

The hair trimming system 10 further comprises a release button 18 which is disposed on the handle 12, and moveable with respect to the handle 12 to push the head 14 away from the handle 12. The release button 18 is therefore configured to abut the head 14 when moved towards the head 14.

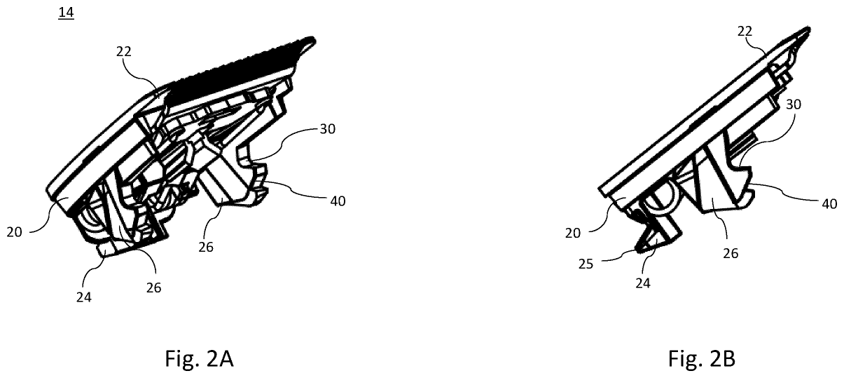

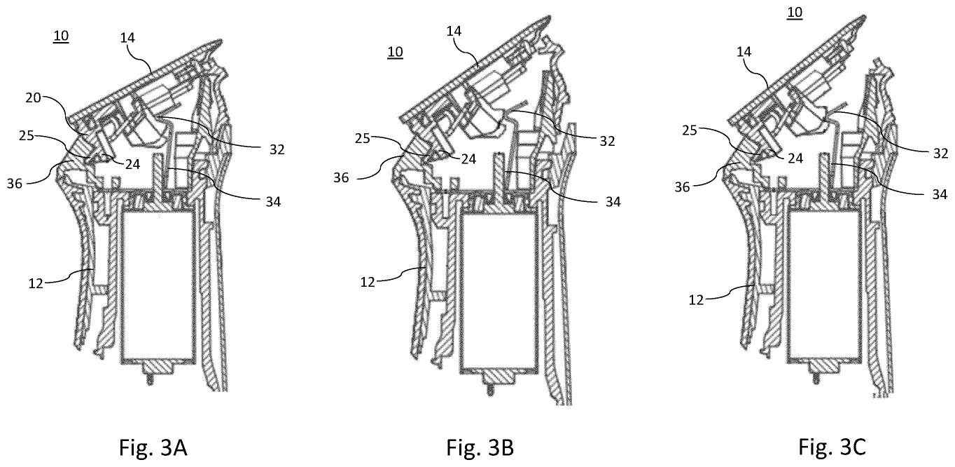

FIGS. 2A and 2B show the head 14 in isolation. The head 14 comprises abase 20 and a guard 22. The base 20 is configured to be received in the handle 12 of the hair trimming system 10 (as shown in FIGS. 3A-3C), and the guard 22 is configured to receive the cutting unit 16 for cutting hair.

The base 20 comprises a connecting portion 24 which is configured to cooperate with the handle 12 to connect the handle 12 to the head 14, and to permit pivoting movement of the head 14 with respect to the handle 12 (as shown in FIGS. 3A-3C).

In this example the connecting portion 24 comprises a locking hook 25 which cooperates with a locking overhang 36 of the handle 12 (shown in FIGS. 3A-3C). The locking overhang 36 detachably retains the locking hook 25 within the handle 12. Cooperation of the locking hook 25 with the locking overhang 36 permits pivoting movement of the head 14 with respect to the handle 12 about the locking hook 25, whilst allowing detachment of the head 14 from the handle 12.

In other examples, the connecting portion may be pivotably connected to the handle with a pin or any other mechanism which does, or does not, allow detachment of the head from the handle.

The base 20 of the head 14 comprises a pair of projecting portions 26, which project away from the guard 22.

Each projecting portion 26 comprises a main indentation 30 and an intermediate indentation 40. The main indentation 30 and the intermediate indentation 40 on each projecting portion are identical, and so the only a single main indentation 30 and intermediate indentation will be described hereinafter. The main indentation 30 is closer to the guard 22 on the projecting portion 26 than the intermediate indentation 40 is.

In other examples, the base may comprise a single projecting portion, or may have no projecting portion. In examples with no projecting portion, the base may simply comprise a thick layer with the main indentation and the intermediate indentation recessed in the thick layer.

The connecting portion 24 is disposed on an opposing side of the base 20 to the main indentation 30 and the intermediate indentation 40.

FIGS. 3A-3C show cross-sectional views of the first example hair trimming system 10 in an operational configuration, an intermediate configuration, and an open configuration respectively. The head 14 is received in the handle 12, and the handle 12 comprises a holding mechanism, to restrict pivoting movement of the head 13 relative to the handle 12 about the connecting portion 24 so as to secure the head 14 to the handle 12.

The holding mechanism comprises a pair of moveable stops 32, each stop 32 in the form of a hook mounted on the end of a respective leaf spring 34 which is biased towards a locked position relative to the handle 12. Each stop 32 is identical and each stop 32 configured to interact, in the same manner, with the main indentation 30 and the intermediate indentation 40 on a respective protrusion 26 of the head 14. Therefore, only a single stop 32 will be described hereinafter. It will be appreciated that in examples with only a single protrusion, or only a single main indentation and intermediate indentation, there will only be a single corresponding stop.

The stop 32 is configured to be received separately in each of the main indentation 30 and the intermediate indentation 40 on a single protrusion 26. In the locked position, the stop 32 is received in one of the main indentation 30 and the intermediate indentation 40 to secure the head 14 to the handle 12 by preventing pivoting movement of the head 14 relative to the handle 12 about the connecting portion 24. In other examples, the moveable stop may simply be biased to a locked position relative to the handle by any suitable means.

The opposing forces acting on the head 14 from the stop 32 and the locking overhang 36 of the handle 12 prevent the head 14 from moving away from the handle 12 without another external force. Even with an external force, the locking overhang 36 is immovable, such that the connecting portion 24 of the head 14 is effectively held in place, and the stop 32 is biased to the locking position, such that head 14 may move away from the handle 12 at the protrusions 26, on application of an external force, thereby pivoting the head 14 away from the handle 12 about the connecting portion 24.

In FIG. 3A, the hair trimming system 10 is shown in the operational configuration. In the operational configuration, the base 20 of the head 14 is received in the handle 12 and the stop 32 is received in the main indentation 30. In the operational configuration, the hair trimming system 10 may be used to cut hairs.

The main indentation 30 and the intermediate indentation 40 define a peak between them and a continuous surface from the peak to a trough of the respective indentation 30, 40. Therefore, the stop 32 can slide along the surface from the main indentation 30 over the peak and along the surface into the intermediate indentation 40.

The release button 18 disposed in the handle 12 is moveable from a neutral position (as shown in FIGS. 3A and 3C) to a release position (as shown in FIG. 3B). When the hair trimming system 10 is in the operational configuration, and the release button 18 is moved towards the release position, the release button 18 is configured to abut the head 14 to pivot the head 14 about the connecting portion 24 away from the handle 12. Pivoting the head 14 away from the handle 12 in this way causes the stop 32 to slide along the main indentation 30 towards the peak, and when the stop 32 crests the peak (as shown in FIG. 3B), the biased stop 32 automatically pushes the head 14 further away from the handle 12, as it slides along the continuous surface between the peak and the trough of the intermediate indentation 40, until the stop 32 is received in the intermediate indentation 40. When the stop 32 is received in the intermediate indentation 40, the head 14 is pivoted away from the handle 12 relative to the operational configuration, in an open configuration, which is shown in FIG. 3C.

In the open configuration, the head 14 and the handle 12 are partially separated so that the guard 22 of the head 14 containing the cutting unit can be more easily cleaned of cut hairs. Further, in the open configuration, the head 14 can be more easily gripped by a user to detach the head 14 from the handle 12 in a controlled manner. Without the intermediate indentation to catch the stop 32, the head 14 would simply eject from the handle 12 in an uncontrolled manner when the release button 18 is moved to the release position. Therefore, the intermediate indentation 40 performs multiple functions simultaneously, to improve access for cleaning, and to prevent uncontrolled ejection of the head 14 from the handle 12.

From the open configuration, the head 14 can be moved back to the operational configuration, by pushing to head 14 towards the handle 12, which forces the stop 32 out of the intermediate indentation 40 and into the main indentation 30.

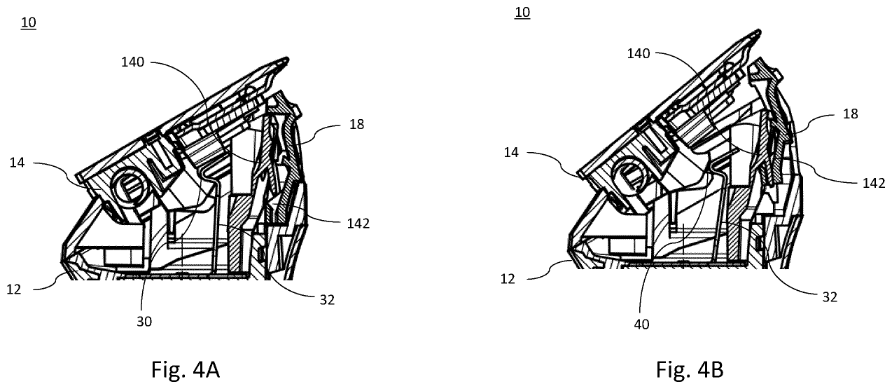

FIGS. 4A and 4B show a cross-sectional view of the hair trimming system 10 at a different, parallel, cross-section to the that shown in FIGS. 3A to 3C. FIGS. 4A and 4B are shown in an operational configuration and in an open configuration respectively. From FIGS. 4A and 4B it can be seen that the handle 12 comprises a release block 140 configured to block movement of the release button 18 beyond the release position (as shown in FIG. 4B). The release block 140 is positioned so that when the release button 18 is in the release position (FIG. 4B), a buttress 142 on the release button 18 abuts the release block 140, and so that the release button 18 cannot extend far enough to abut the head 14 when the head is in the open configuration (i.e. when the head 14 is positioned so that the stop 32 can be received in the intermediate indentation 40). In other words, the release block 140 cooperates with the release button 18 to prevent overshooting of the release button 18.

The release block 140 is positioned so that the release position of the release button 18 is limited to push the head 14 away from the handle 12 until the stop 32 is received in the intermediate indentation 40. In this example, the stop is received on the continuous surface between the peak and the trough of the intermediate indentation 40 when the head 14 is pushed by the release button 18 up to the release position of the release button 18 (i.e. when the release button is still abutting the head 14 at the release position). Then the biasing force on the stop 32 propels the head 14 the rest of the way away from the handle 12, until the stop 32 is received in the trough of the intermediate indentation 40. Limiting the movement of the release button 18 in this manner, builds in a tolerance so that the release button 18 cannot accidentally push the head 14 away from the handle 12 to the extent that the stop 32 is pushed beyond the intermediate indentation 40 to accidentally eject the head 14 fully from the handle 12.

Further, the release button 18 in this example is biased to the neutral position (shown in FIG. 4A) relative to the handle 12. This helps to prevent the release button 18 from inadvertently interfering with the cutting unit 16 in use. The release button 18 is biased to the neutral position by a spring (not shown) which is held by the release button 18, and which is hooked over part of the handle 12. In some examples, the release button may be biased to the neutral position relative to the handle by any suitable means.

In some examples, the release button 18 may be disposed on a guide rail (not shown) which describes an arcuate path, so that the release button 18 moves along the arcuate path between the neutral position and the release position. This helps the release button 18 to reliably contact the same part of the head 14 during pivoting movement of the head 14 about the connecting portion 24.

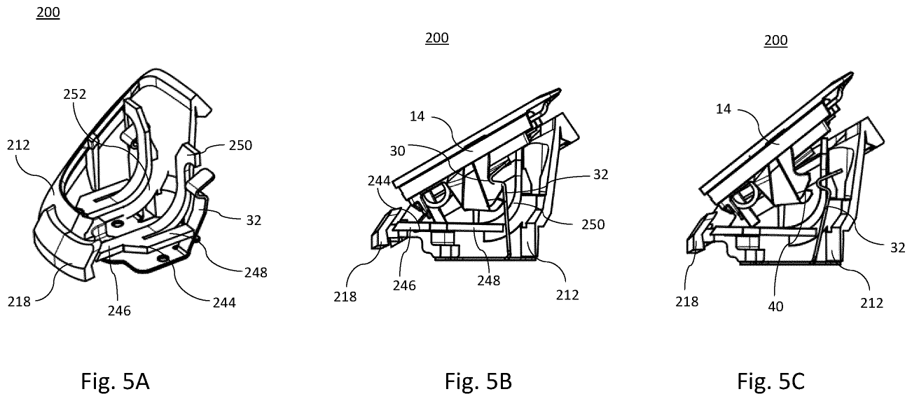

FIGS. 5A-5C show a second example hair trimming system 200 having the same head 14 and stop 32 as the first example hair trimming system 10 and differing in having a second example handle 212 and release button 218. FIG. 5A shows only the second example handle 212 and release button 218, and FIGS. 5B and 5C show a cross-sectional view of the second example hair trimming 200 in the operational configuration and the open configuration respectively.

In this example, the release button 218 is configured to move relative to the handle 12 between a neutral position and a release position, in a direction perpendicular to movement of the head 14 away from the handle 12. The release button 218 is configured to cooperate with an actuation component 244. The actuating component comprises, for each stop 32, a button arm 246, configured to cooperate with the release button 218, and a pair of actuation arms 248, 250 which are branched from the button arm 246. A first actuation arm 248 is configured to push the stop 32 away from the locked position, when the release button 218 is actuated. The second actuation arm 250 comprises an arcuate section, which is configured to transform movement of the release button 218 to movement of an end of the second actuation arm 250, offset 90 degrees from movement of the release button 218, to push the head 14 away from the handle 12. This is achieved by a guide rail 252 which describes an arcuate surface along which the arcuate section of the second actuation arm 250 can travel to guide the second actuation arm 250 to induce movement of the head 14 away from the handle 212. It will be appreciated that the movement offset of the second actuation arm 250 from the movement of the release button 218 need not be 90 degrees, and may be any suitable offset from the movement of the release button 18.

Therefore, actuation of the release button 218 simultaneously pushes the stop 32 away from the locked position (as shown in FIG. 5A), to remove the stop 32 from either the main indentation 30 or the intermediate indentation 40 of the head 14 (as shown in FIG. 5B), and pushes the head 14 away from the handle 12. Then releasing the release button 218 allows it to return to its original position, due to the biasing of the stop 32, which also allows the stop 32 to return to the locked position. Since the head 14 is moved away from the handle 212, the stop then returns into the intermediate indentation 40 so that the hair trimming system 200 is in the open configuration.

In some examples, for example in the first example hair trimming system 10, the actuation component 244 may be inverted to operate with a release button which moves in the direction of movement of the head 14 away from the handle 12. In such an example, an arm may cooperate with the stop 32 to pull the stop from the main indentation or the intermediate indentation.

This example allows the main indentation 30 to be relatively sharp, such that simply pulling the head 14 away from the handle 12 manually would not decouple the stop 32 from the main indentation 30, but only actuation of the release button 18 allows decoupling of the stop 32 from the main indentation 30. The continuous surface from the trough of the intermediate indentation 40 to the peak may have a relatively gradual change in curvature, in this example and/or in the first example hair trimming system 10, in order to enable manual pushing of the head 14 towards the handle 12 to push the stop 32 out of the intermediate indentation 40 and back into the main indentation 30.

Although the examples show the release button being moved along a linear path to move the head 14 away from the handle 12, 212, in other examples, the release button may be moved by pivoting or by rotation about a point, which induces movement of an actuating arm to move the head away from the handle.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A hair trimming system comprising a handle and a head, the head comprising a cutting unit for cutting hairs, and the head being moveable relative to the handle, wherein:
the head comprises a base configured to be received in the handle, wherein the base comprises a connecting portion configured to cooperate with the handle to connect the handle and the head, and to permit pivoting movement of the head with respect to the handle about the connecting portion, and the base comprises a main indentation and an intermediate indentation;
the handle comprises a holding mechanism comprising a moveable stop configured to be received separately in each of the main indentation and in the intermediate indentation, to restrict pivoting movement of the head relative to the handle about the connecting portion so as to secure the head to the handle, wherein the stop is biased to a locked position relative to the handle, wherein in the locked position, the stop is received in one of the main indentation and the intermediate indentation, to secure the head to the handle,
wherein when the stop is received in the main indentation, the base of the head is received within the handle in an operational configuration, and when the stop is received in the intermediate indentation, the head is pivoted away from the handle relative to the operational configuration, in an open configuration.

2. A hair trimming system according to claim 1, wherein the stop is mounted on the end of a leaf spring.

3. A hair trimming system according to claim 1, wherein the head is detachable from the handle.

4. A hair trimming system according to claim 3, wherein the connecting portion of the head comprises a locking hook and the handle comprises a corresponding locking overhang to detachably retain the locking hook within the handle.

5. A hair trimming system according to claim 1, further comprising a release button disposed on the handle, and moveable with respect to the handle from a neutral position to a release position, wherein the release button is configured to abut the head when moved towards the release position, to push the head away from the handle, to pivot the head about the connecting portion relative to the handle.

6. A hair trimming system according to claim 5, wherein the release button is disposed on a guide rail describing an arcuate path, such that the release button is configured to move between the neutral position and the release position along the arcuate path.

7. A hair trimming system according to claim 5, wherein the handle comprises a release block configured to block movement of the release button beyond the release position, wherein when the release button abuts the head at the release position, the stop is received in the intermediate indentation.

8. A hair trimming system according to claim 7, wherein the main indentation and the intermediate indentation define a peak therebetween, wherein the intermediate indentation comprises a continuous surface from the peak to a trough of the intermediate indentation.

9. A hair trimming system according to claim 7, wherein when the release button abuts the head at the release position, the stop is received on the continuous surface between the peak and the trough of the intermediate indentation, such that a biasing force on the stop to the locked position causes the stop to propel the head away from the handle until the stop is received in the trough of the intermediate indentation.

10. A hair trimming system according to claim 5, wherein the release button comprises a protrusion configured to interact with the stop, to push or pull the stop away from the locked position when the release button is moved towards the release position.

11. A hair trimming system according to claim 1, wherein the head comprises two adjacent main indentations and two adjacent intermediate indentations, and the handle comprises two corresponding stops, each stop configured to be received in one of the main indentations and one of the intermediate indentations.

12. A hair trimming system according to claim 3, comprising multiple interchangeable heads.
